(19) United States
(12) Patent Application Publication
(10) Pub. No.: US 2012/0208405 A1
(43) Pub. Date: Aug. 16, 2012

(54) PLUG CONNECTOR HAVING AN ARRANGEMENT OF TERMINALS AND A CONNECTOR ASSEMBLY HAVING THE SAME

(75) Inventors: CHIEN-CHIUNG WANG, New Taipei (TW); QING-MAN ZHU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/368,592

(22) Filed: Feb. 8, 2012

(30) Foreign Application Priority Data
Feb. 16, 2011 (CN) 201110039047.5

(51) Int. Cl. H01R 24/28

(52) U.S. Cl. 439/676

(57) ABSTRACT

A connector assembly (1) includes a receptacle connector (200) and a plug connector (100). The receptacle connector has a receptacle housing (20), a number of primary contacts and periphery contacts (22) secured in the receptacle housing. The plug connector includes a plug housing (10), a supporting member (113), and a conductive member received in the plug housing. The conductive member includes a paddle board (110) having a number of conductive pads (a1, a3, a4) for contacting with the primary contacts, and a number of terminals (12) supported by the supporting member for contacting with the periphery contacts. The supporting member is secured on the paddle board to separate the terminals from the paddle board along an up-to-bottom direction.

### BACKGROUND OF THE INVENTION

1. Field of the Invention

The present invention relates to a plug connector and a connector assembly, and more particularly to a SFP (Small Form-factor Pluggable) plug connector and a connector assembly having the same for application in high speed signal transmission.

2. Description of Related Art

U.S. Pat. No. 7,798,820 issued to Hong on Sep. 21, 2010 discloses an SFP connector assembly having a plug connector and a receptacle connector. The plug connector includes a paddle board inserted in the receptacle connector. The paddle board has opposite upper and lower faces, a row of first conductive pads and a row of second conductive pads formed on the upper face, a row of third conductive pads and a row of fourth conductive pads formed on the lower face. The receptacle connector includes an insulative housing defining a slot, and a first through fourth contacts received in the insulative housing. The first and second contacts are disposed above the slot for contacting with the first and second conductive pads, respectively. The third and fourth contacts are disposed below the slot for contacting with the third and fourth conductive pads, respectively.

U.S. Patent Publication No. 2012/0015563 published on Jan. 19, 2012 discloses a connector assembly including a receptacle connector and a pluggable connector having a plug and a printed circuit. The receptacle connector includes a housing comprising an upper mating receptacle and a lower slot, a plurality of contacts in the receptacle, and a plurality of contacts exposed to the slot. The plug of the pluggable connector is received in the mating receptacle. The printed circuit of the pluggable module is received in the slot. The receptacle contact comprises a receptacle mating segment extending within the mating receptacle and engaging with a mating contact of the plug of the pluggable module. The slot contact comprises a slot mating segment extending within the slot and engaging the printed circuit of the pluggable module.

A plug connector having a different arrangement of terminals and a connector assembly having the same is desired.

### SUMMARY OF THE INVENTION

Accordingly, an object of the present invention is to provide a plug connector and a connector assembly having the same, the plug connector including a plurality of terminals separable from a paddle board for contacting with a plurality of contacts of the receptacle connector.

In order to achieve the object set forth, a connector assembly includes a receptacle connector and a plug connector. The receptacle connector includes a receptacle housing having a mating slot and a top wall, a plurality of contact modules each including three primary contacts exposed to the mating slot, and a plurality of periphery contacts arranged on the top wall of the receptacle housing. The plug connector comprises a conductive member received in the plug housing. The conductive member includes a paddle board inserted in the mating slot and having opposite first and second faces, a row of first conductive pads disposed at the first face, a row of second conductive pads and a row of third conductive pads formed on the second face of the paddle board for respectively contacting with the primary contacts, and a plurality of terminals secured in the supporting member and extending forwardly beyond the supporting member for contacting with the periphery contacts of the receptacle connector. The supporting member is secured on the paddle board to separate the terminals from the rows of first through third conductive pads along an up-to-bottom direction.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a connector assembly in accordance with the present invention;

FIG. 2 is an exploded perspective view showing the connector assembly as shown in FIG. 1;

FIG. 3 is a perspective view showing primary and periphery contacts of the receptacle connector mating with the paddle board and the terminals of the receptacle connector;

FIG. 4 is perspective view showing the primary and periphery contact of the plug connector;

FIG. 5 is an exploded perspective view of FIG. 4;

FIG. 6 is an exploded perspective view similar to FIG. 5, taken from another aspect;

FIG. 7 is a perspective view showing periphery contacts separated from the receptacle housing; and

FIG. 8 is an exploded perspective view showing the receptacle connector.

### DETAILED DESCRIPTION OF THE PREFERRED EMBODIMENT

Reference will now be made in detail to the preferred embodiment of the present invention.

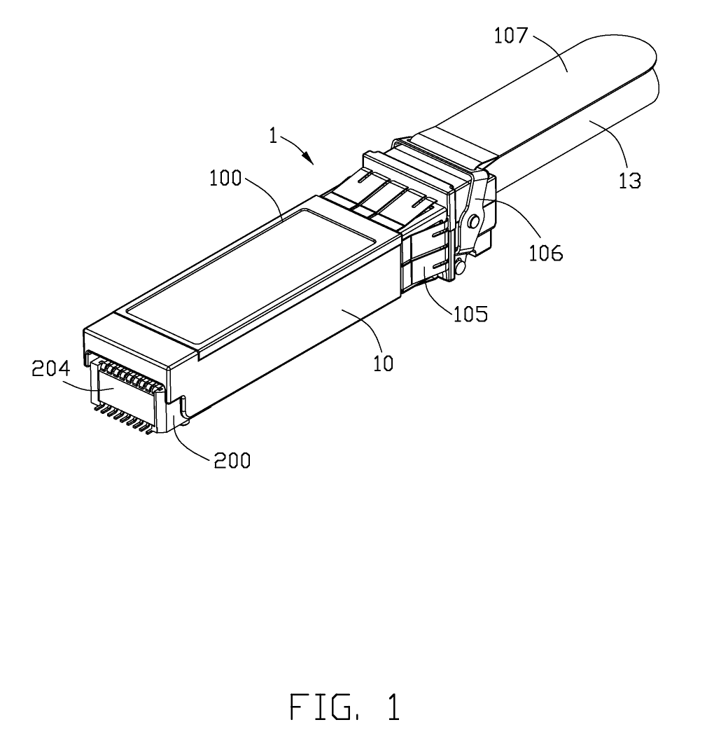

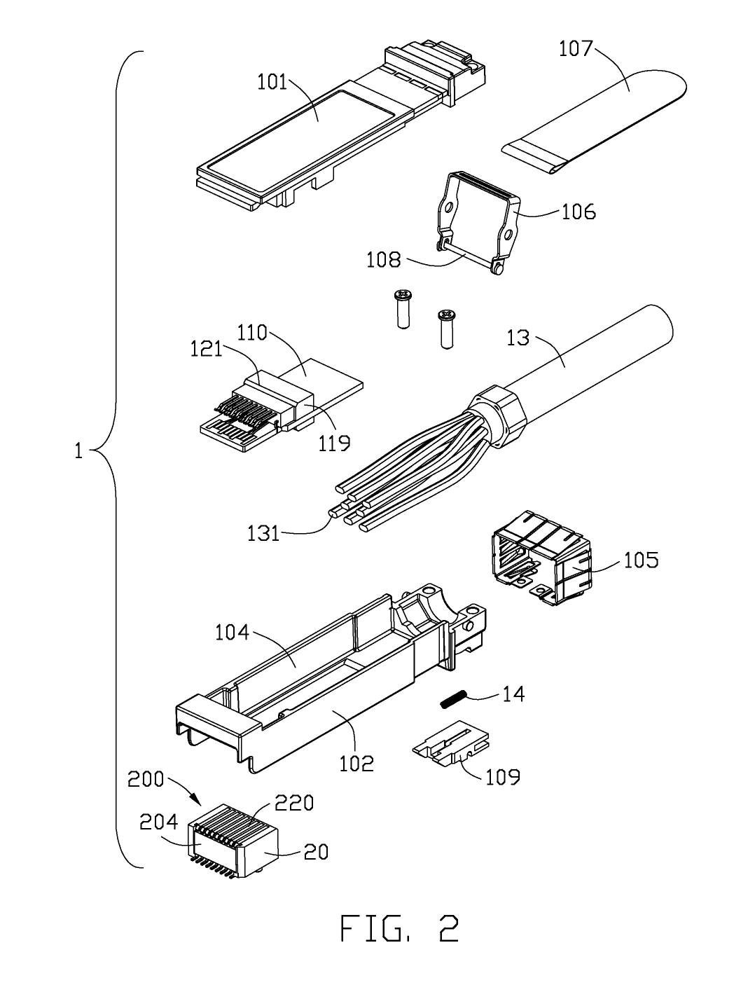

Referring to FIGS. 1 and 2, a connector assembly 1 in accordance with the present invention includes a plug connector 100 connected with a cable 13 and a receptacle connector 200 mated with the plug connector 100. Each cable 13 includes a plurality of wires 131.

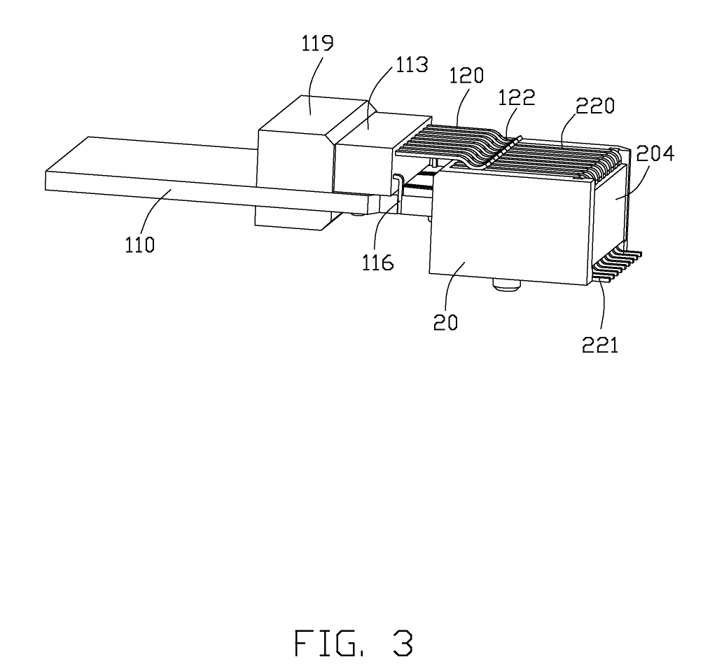

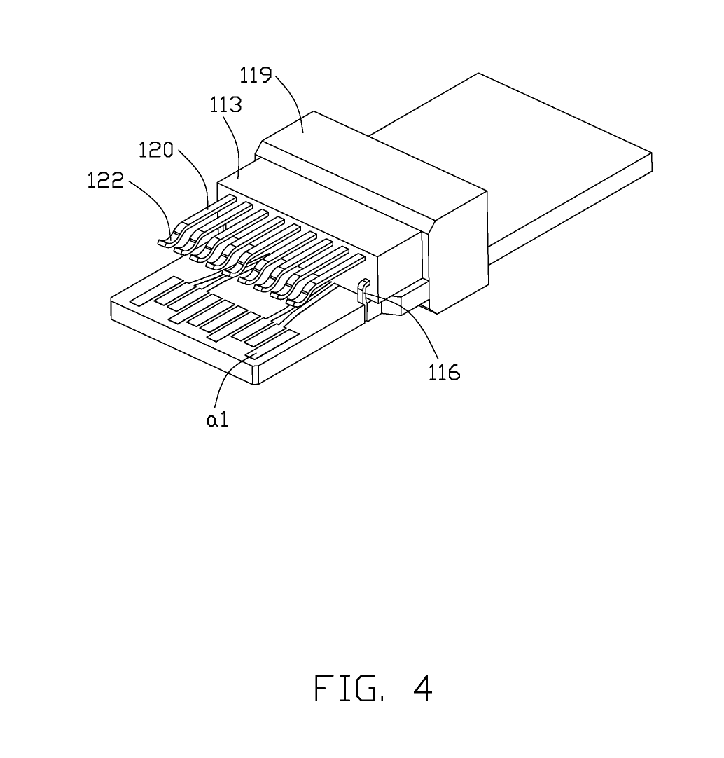

Referring to FIGS. 2 to 6, the plug connector 100 comprises a plug housing 10, a gasket 105 attached to the housing 10, a latching mechanism assembled to the housing 10, a supporting member 113 made from insulative material and a conductive member received in the plug housing 10. The plug housing 10 includes an upper portion 101, a lower portion 102 cooperated with the upper portion 101, and a receiving space 104 defined between the upper portion 101 and the lower portion 102. The latching mechanism includes a lever 106 pivotably mounted on the housing 10, a puller 107 mounted at an upper portion of the lever 106, a pin 108 connected with a lower portion of the lever 106, a slider 109 operated by the pin 108, and a spring 14 received in the slider 109.

The supporting member 113 includes a pair of soldering tails 116 and a pair of mounting posts 117 extending downwardly therefrom.

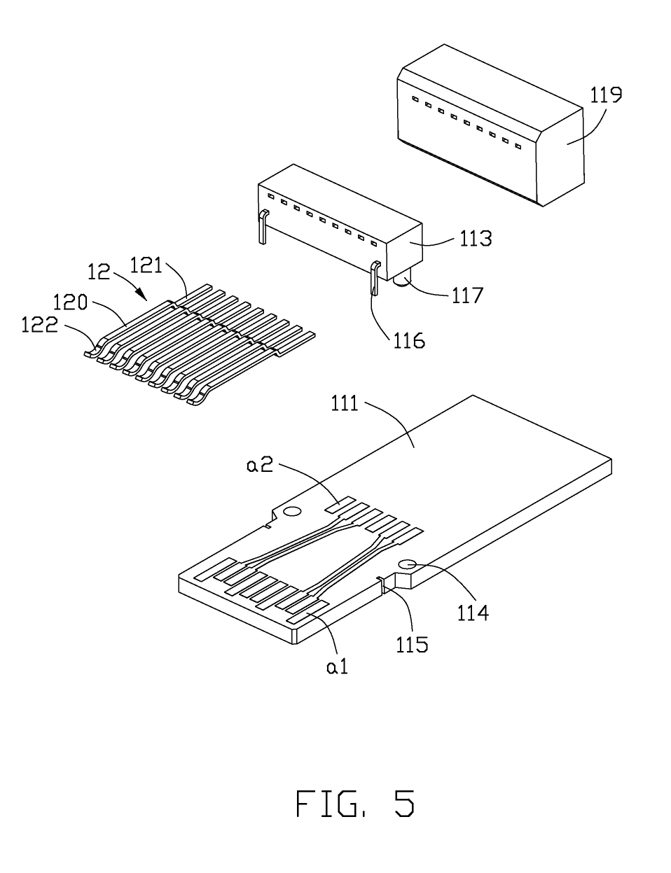

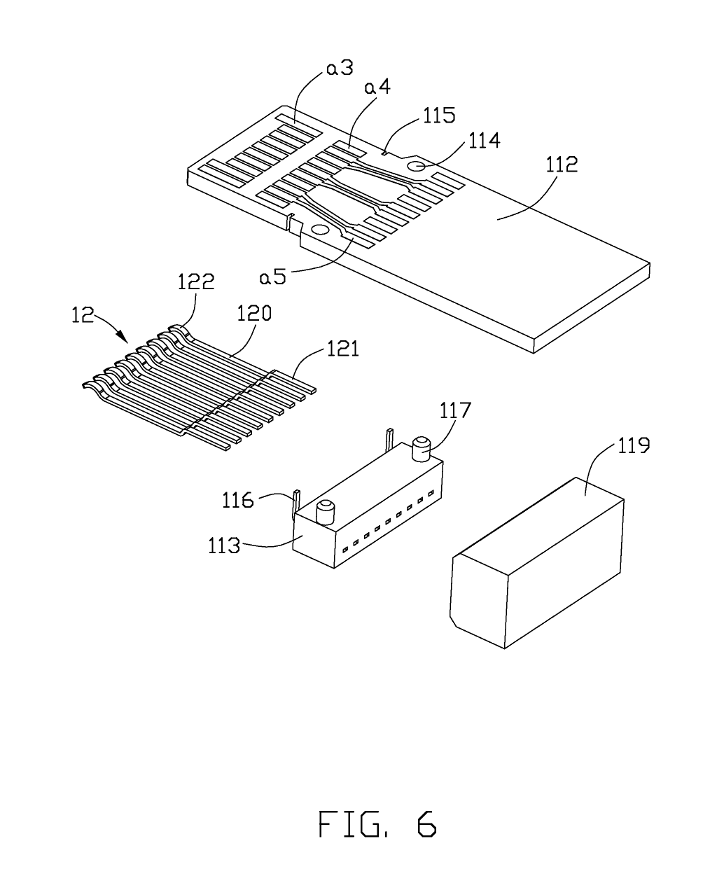

The conductive member includes a paddle board 110 and a plurality of terminals 12. Referring to FIG. 5, the paddle board 110 has a row of first conductive pads a1 and a row of first soldering pads a2 formed on an upper face 111 of the paddle board 110. Referring to FIG. 6, the paddle board 110 has a row of second conductive pads a3, a row of third conductive pads a4, and a row of second soldering pads a5 formed on a lower face 112 of the paddle board 110 in sequence. Several of the first conductive pads a1 are connected with the first soldering pads a2. Several of the third conductive pads a3 are connected with the second soldering pads a5. The paddle board 110 defines a pair of slits 115 at two opposite edges thereof, and a pair of mounting holes 114 for insertion of the mounting posts 117 of the supporting member 113.

Each terminal 12 includes a contact portion 122, a tail portion 121 and a middle portion 120 formed between the contact portion 122 and the tail portion 121.

Referring to FIGS. 1-6, in assembling of the plug connector 100, the middle portions 120 of the terminals 12 are secured in the supporting member 113, with the contact portions 122 and the tail portions 121 extending outwardly from the supporting member 113. The soldering tails 116 of the supporting member 113 are soldered in the slits 115 of the paddle board 110 to secure the supporting member 113 on the paddle board 110. The terminals 12 are spaced above the upper face 111 of the paddle board 110. The wires 131 of the cable 13 are soldered onto the first and second soldering pads a2, a5. The first and second soldering pads a2, a5 and the tail portions 121 of the terminals 12 are covered by adhesive 119.

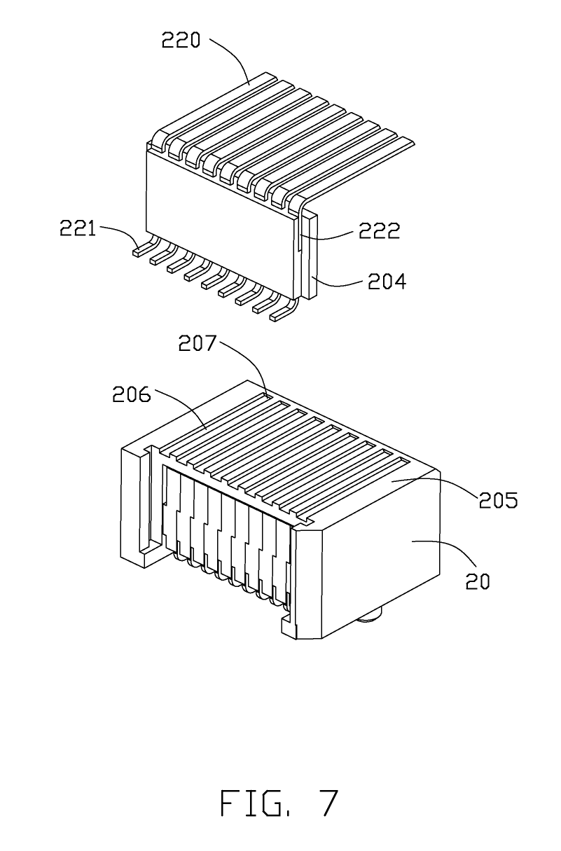

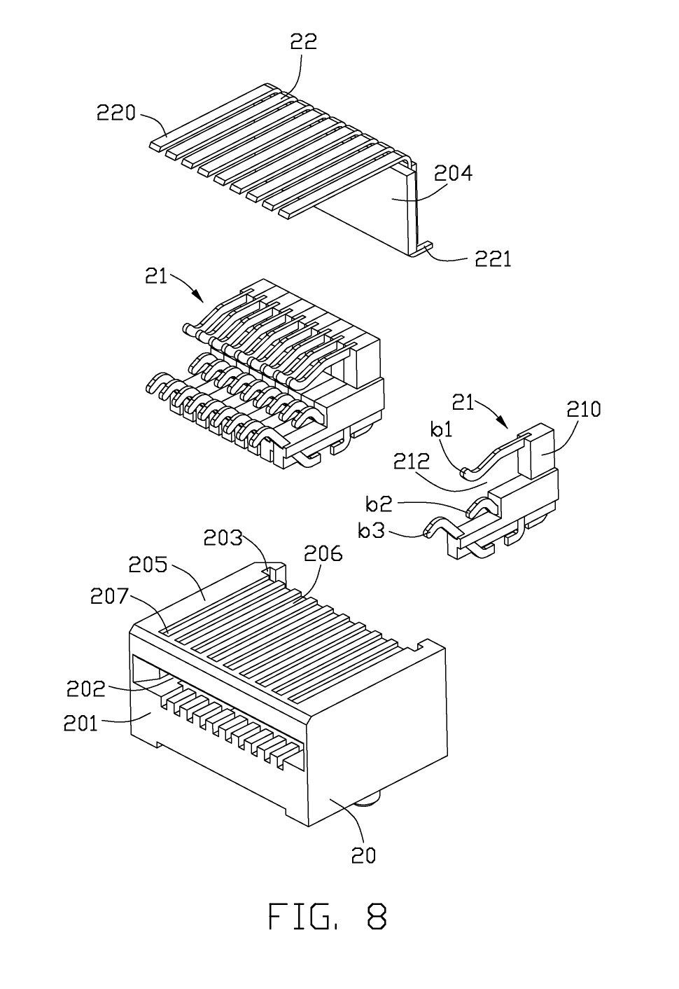

Referring to FIGS. 7-8, the receptacle connector 200 includes a receptacle housing 20, a plurality of contact modules 21 inserted in the receptacle housing 20, an insulative plate 204 and a plurality of periphery contacts 22 insert-molded in the insulative plate 204. Each periphery contact 22 is formed into a Z-shape and has a vertical portion 222 insert-molded in the insulative plate 204, a contact portion 220 and a tail portion 221 perpendicular to the insulative plate 204.

The receptacle housing 20 comprises a top wall 205, a bottom wall 201, and a mating slot 202 between the top and bottom walls 205, 201 for insertion of the paddle board 110. The top wall 205 of the receptacle housing 20 defines a plurality of channels 206 for accommodating the periphery contacts 22. Each channel 206 has a pre-pressing recess 207 defined at a front end thereof for pre-pressing a corresponding periphery contact 22. The receptacle housing 20 defines a guiding slot 203 at a rear portion thereof.

Each contact module 21 has a wafer 210, a plurality of primary contacts insert-molded with the wafer 210 and an inserting slot 212. The plurality of primary contacts comprise a first contact having a first contact portion b1 disposed above the inserting slot 22, a second contact having a second contact portion b2 and a third contact having a third contact portion b3 disposed below the inserting slot 212. The third contact portion b3 is disposed in front of the second contact portion b2.

In assembling of the receptacle connector 200, the plurality of contact modules 21 are inserted in the receptacle housing 20, with the first through third contact portions b1-b3 of the first through third contacts exposed to the mating slot 202. The front end of the contact portion 220 is pre-pressed in the pre-pressing recess 207. The insulative plate 204 is inserted into the guiding slot 203 along an up-to-bottom direction. The contact portions 220 of the periphery contact 22 are inserted in the channels 206.

When the plug connector 100 is mated with receptacle connector 200, the paddle board 110 is inserted into the mating slot 202, with the first through third contact portions b1-b3 of the first through third contacts respectively contacting with the first through third conductive pads a1, a3, a4. The contact portions 122 of the terminals 12 contact with the contact portions 220 of the periphery contacts 22.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug connector for mating with a receptacle connector having a mating slot, a plurality of primary contacts exposed to the mating slot, and a plurality of periphery contacts, the plug connector comprising:
a plug housing;
a supporting member; and
a conductive member received in the plug housing, said conductive member including a paddle board inserted in the mating slot and having opposite first and second faces, a row of first conductive pads disposed at the first face, a row of second conductive pads and a row of third conductive pads formed on the second face of the paddle board for respectively contacting with the primary contacts, and a plurality of terminals secured in the supporting member and extending forwardly beyond the supporting member for contacting with the periphery contacts of the receptacle connector, said supporting member being secured on the paddle board to separate the terminals from the rows of first through third conductive pads along an up-to-bottom direction.

2. The plug connector as claimed in claim 1, wherein said first face constitutes an upper face of the paddle board and said second face constitutes a lower face of the paddle board, said terminals being distanced above the upper face of the paddle board.

3. The plug connector as claimed in claim 1, wherein said paddle board defines a pair of slits, and said supporting member has a pair of soldering tails soldered in the pair of slits.

4. The plug connector as claimed in claim 1, wherein said paddle board has a plurality of first and second soldering pads respectively formed on the first face and the second face of the paddle board for connecting with a cable, each terminal having a contact portion for contacting with the periphery contact, a middle portion secured in the supporting member and a tail portion extending outwardly from the supporting member, said plug connector comprising a melt adhesive covering the first and second soldering pads and the tail portions of the terminals.

5. A connector assembly comprising:
a receptacle connector including:
a receptacle housing having a mating slot and a top wall, a plurality of contact modules each including three primary contacts exposed to the mating slot, and a plurality of periphery contacts arranged on the top wall of the receptacle housing; and
a plug connector comprising:
a plug housing;
a supporting member; and
a conductive member received in the plug housing, said conductive member including a paddle board inserted in the mating slot and having opposite first and second faces, a row of first conductive pads disposed at the first face, a row of second conductive pads and a row of third conductive pads formed on the second face of the paddle board for respectively contacting with the primary contacts, and a plurality of terminals secured in the supporting member and extending forwardly beyond the supporting member for contacting with the periphery contacts of the receptacle connector, said supporting member being secured on the paddle board to separate the terminals from the rows of first through third conductive pads along an up-to-bottom direction.

6. The connector assembly as claimed in claim 5, wherein said first face constitutes an upper face of the paddle board and said second face constitutes a lower face of the paddle board, said terminals being distanced above the upper face of the paddle board, said three primary contacts in each contact module including a first contact in contact with the first conductive pad, a second contact in contact with the second conductive pad, and a third contact in contact with the third conductive pad.

7. The connector assembly as claimed in claim 6, wherein each contact module of the receptacle connector comprises a wafer with which the first through third contacts are insert molded.

8. The connector assembly as claimed in claim 6, wherein said top wall of the receptacle housing defines a plurality of channels for accommodating the periphery contacts.

9. The connector assembly as claimed in claim 5, wherein said receptacle connector comprises an insulative plate inserted in the receptacle housing along an up-to-bottom direction, said periphery contacts being insert-molded in the insulative plate.

10. An electrical connector assembly comprising:
a plug connector including:
a paddle printed circuit board defining conductive pads on both two opposite surfaces along a front edge region thereof;
a connector set mounted upon one of the two opposite surfaces and including a first set of contacts;
a receptacle connector for mounting to another printed circuit board parallel to said paddle printed circuit board,
said receptacle connector mated with the plug connector and including:
an insulative housing set defining a slot so as to have the whole front edge region of the paddle printed circuit board fully received therein without exposure;
a second set of contacts disposed in the housing and exposed in the slot to mechanically and electrically connect the corresponding conductive pads, respectively;
a third set of contacts upwardly exposed upon the housing to an exterior and mechanically and electrically connecting to the first set of contacts, respectively.

11. The electrical connector assembly as claimed in claim 10, wherein the third set of contacts are not deflectable during mating while both the first set of contacts and the second set of contacts are deflectable during mating.

12. The electrical connector assembly as claimed in claim 10, wherein the first set of contacts extend forwardly while not beyond the front edge region of the paddle printed circuit board.

13. The electrical connector assembly as claimed in claim 10, wherein tails of the second set of contacts are hidden under the housing while those of the third set of contacts are exposed outside of the housing.

14. The electrical connector assembly as claimed in claim 10, wherein the first set of contacts are upwardly exposed to the exterior.

15. The electrical connector assembly as claimed in claim 10, wherein said housing set includes a housing frame, and a plurality of wafers each lying in a vertical plane defined by a front-to-back direction and a vertical direction perpendicular to said front-to-back direction, and commonly transversely stacked with one another under condition that the second set of contacts are integrally formed therewith and said slot is formed therein.

16. The electrical connector assembly as claimed in claim 15, wherein said third set of contacts are unified by an insulative plate lying in another vertical plane defined by the front-to-back direction and a transverse direction perpendicular to said front-to-back direction and said vertical direction.

17. The electrical connector assembly as claimed in claim 16, wherein said insulative plate is configured to be assembled to the housing frame in the vertical direction.
